(19) United States
(12) Patent Application Publication
(10) Pub. No.: US 2002/0144576 A1
(43) Pub. Date: Oct. 10, 2002

(54) Micro-cutting tool and production method for 3-dimensional microstructures

(76) Inventors: Shih-Chou Chen, Hsinchu (TW); Chung-Kuang Hsieh, Feng-Yuan City (TW); Yuh-Sheng Lin, Hsinchu (TW)

Correspondence Address: Keith Kline, PRO-TECHTOR INTERNATIONAL SERVICES, 20775 Norada Court, Saratoga, CA, 95070-3018, US

(21) Appl. No.: 09/827,506

(22) Filed: Apr. 6, 2001

(51) Int. Cl. B23B 1/00; B23B 3/00

(52) U.S. Cl. 82/1.11; 82/117

(57) ABSTRACT

A production method for 3-dimensional microstructures, using a micro-cutting tool with cutting edges for working a surface of a work object and generating a 3-dimensional microstructure that is inverted to the cutting edges of the micro-cutting tool. Production of the micro-cutting tool is performed by generating a photoresist mold of equal shape on a substrate using photolithography, then electroplating in said photoresist mold. After that, the micro-cutting tool is vertically put on the work object, generating the 3-dimensional microstructure on the surface of the work object.

### BACKGROUND OF THE INVENTION

1. Field of the Invention

The present invention relates to a micro-cutting tool and a production method for 3-dimensional microstructures, particularly to a micro-cutting tool for working a planar object by micro-cutting or milling.

2. Description of Related Art

In the area of optical fiber communication and optoelectronics, optical display device, liquid crystal display devices on a microscopic scale regularly need to be produced by machining or chemical etching. Microdevices often have surfaces with 3-dimensional structures. An example therefore is the 3-dimensional structure of a backlighting assembly of a liquid crystal display, having a Fresnel lens, blazed grating, and V-grooves and U-grooves on the blazed gratings.

Working these 3-dimensional structures is normally done by conventional machining or by etching. Machining uses a cutting tool to engrave the desired 3-dimensional microstructure on the surface of the working object. However, accuracy of size and form of the microstructure depends on precision of machining and of the cutting tool. Regular machining is done with an accuracy of a hundredth of a millimeter, precise machining with an accuracy of a thousandth of a millimeter. Therefore, mechanically cut 3-dimensional structures do not meet precision requirements of modern optical fiber communication and optoelectronics. Furthermore, cutting tools used for conventional machining need to be produced by grinding. As shown in FIG. 9, a cutting tool 1 has peaks 1A and recessions 1B formed by a grinding tool, normally with a not perfectly sharp edge. Thus the peaks 1A and recessions 1B are not completely sharp, but still have a rounded shape. Accordingly, projections and grooves on the 3-dimensional microstructure cut by the cutting tool 1 are rounded off, which reduces precision. Since there is a great variation of shapes of 3-dimensional microstructures, like V-grooves for optical fibers of which tens of thousands are cut and hemispheres and pyramids for liquid crystal display backlightings, mechanical production thereof is cumbersome.

On the other hand, chemical etching of 3-dimensional microstructures is performed by first partly covering a surface of a working object by photoresist lithography, then etching using a chemical substance. Photolithography and etching are repeated with other patterns, resulting in the 3-dimensional microstructures on the working object. Referring to FIGS. 10-15, for producing a microstructure like a Fresnel lens, photoresist formation 3 is applied to a working object 2, and a pattern 4 is formed by exposure to light, as shown in FIG. 11. Then, as shown in FIG. 12, grooves 5 are shaped by etching. As shown in FIG. 13, another layer of the photoresist formation 3 is applied to the working object 2, and, as shown in FIG. 14, other grooves 5A are etched besides the grooves 5, with different depths. Repeating this process several times produces a pattern of grooves on the surface of the working object 2, and a 3-dimensional microstructure results, forming a Fresnel lens, as shown in FIG. 15.

However, complicated microstructures require many repetitions of photolithography and etching, slowing down production. This is not suitable to mass production and leads to high costs. Furthermore, etched structures have steps, there is no way to form continuous slopes or curved surfaces.

### SUMMARY OF THE INVENTION

It is an object of the present invention to provide a production method using a micro-cutting tool, allowing for an increased variability of shapes and better precision of size to overcome limitations of conventional machining methods.

Another object of the present invention is to provide a micro-cutting tool and a production method for 3-dimensional microstructures with increased speed and reduced cost of production.

The present invention can be more fully understood by reference to the following description and accompanying drawings.

### BRIEF DESCRIPTION OF THE DRAWINGS

FIGS. 1-5 are schematic illustrations of the production method for a micro-cutting tool and 3-dimensional microstructures of the present invention.

FIG. 6 is a perspective view of the micro-cutting tool of the present invention.

FIG. 7 is a perspective view of using the micro-cutting tool of the present invention in an embodiment for fly cutting.

FIG. 8 is a perspective view of using the micro-cutting tool of the present invention in an embodiment for circular cutting.

FIG. 9 is a schematic illustration of a conventional cutting tool for cutting 3-dimensional microstructures.

FIGS. 10-15 are schematic illustrations of a conventional chemical etching process for producing 3-dimensional microstructures.

### DETAILED DESCRIPTION OF THE PREFERRED EMBODIMENTS

The method of the present invention uses LIGA technology for producing a micro-cutting tool by electroplating. The micro-cutting tool is then vertically applied to a surface of a work object, and a 3-dimensional structure on the surface of the work object is generated by fly cutting or milling. Since the micro-cutting tool is formed by photolithography, form and size precision are given by the precision of light exposure, which accurately determines size and shape of the micro-cutting tool. Consequently, the work object has a precisely shaped and sized microstructure.

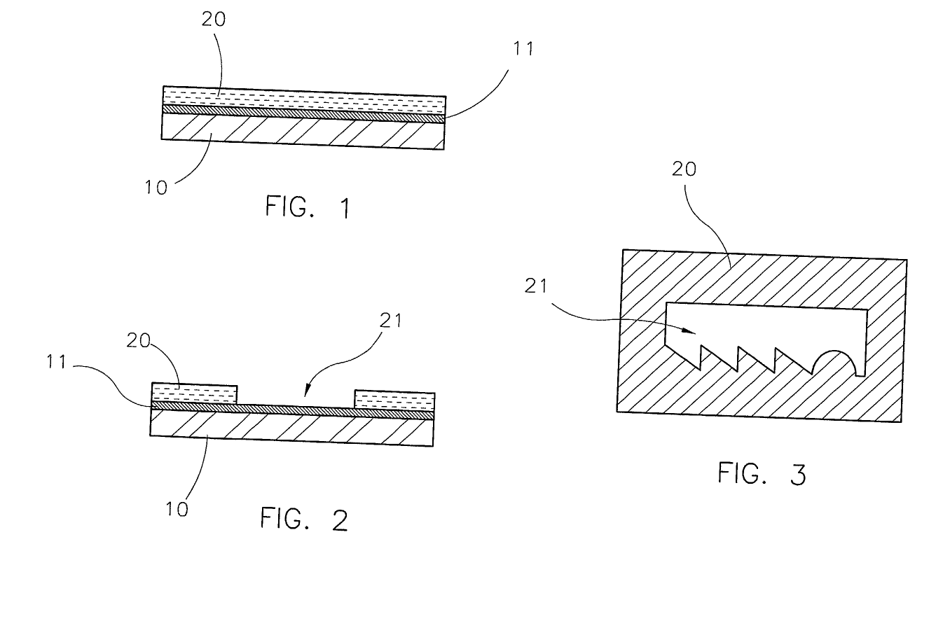

Referring to FIGS. 1-5, in the production method for 3dimensional microstructures of the present invention, first a micro-cutting tool 30 is formed by photolithography. As shown in FIG. 1, a seed layer 11 is laid on a substrate 10, then a photoresist formation 20 is applied to the seed layer 11. After this, as shown in FIG. 2, a pattern is formed on the photoresist formation 20 by photolithography, creating an photoresist mold 21 for forming the micro-cutting tool 30. As shown in FIG. 3, the photoresist mold 21 is shaped like the micro-cutting tool 30 to be produced, outlined by the mask used. Therefore, complicated shapes of the micro-cutting tool 30 are possible. Form and size precision of the micro-cutting tool 30 is completely determined by the precision of the mask.

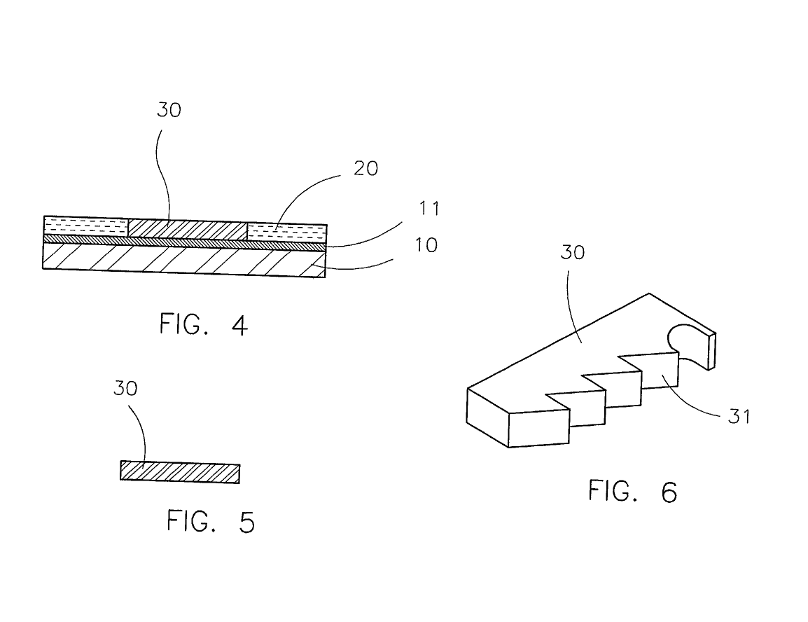

Referring to FIG. 4, after forming the pattern, the micro-cutting tool 30 is produced by electroplating in the photoresist mold 21. As material for electroplating, Ni, NiFe alloy, NiCo alloy, NiW alloy, or a composition of Ni and SiC are used, the physical characteristic thereof determined by the method of electroplating. Furthermore, the material used needs to be hard to serve as cutting material. As shown in FIG. 5, after electroplating the micro-cutting tool 30 is removed. As shown in FIG. 6, the micro-cutting tool 30 is shaped like the photoresist mold 21. Form and size precision of the micro-cutting tool 30 is exactly as form and size precision of the forming pattern.

Referring again to FIG. 6, the micro-cutting tool 30 has edges 31 according to the 3-dimensional microstructure to be formed. When cutting a work object 40 with the micro-cutting tool 30, the edges 31 are vertically put on the surface of the work object, generating the 3-dimensional microstructure.

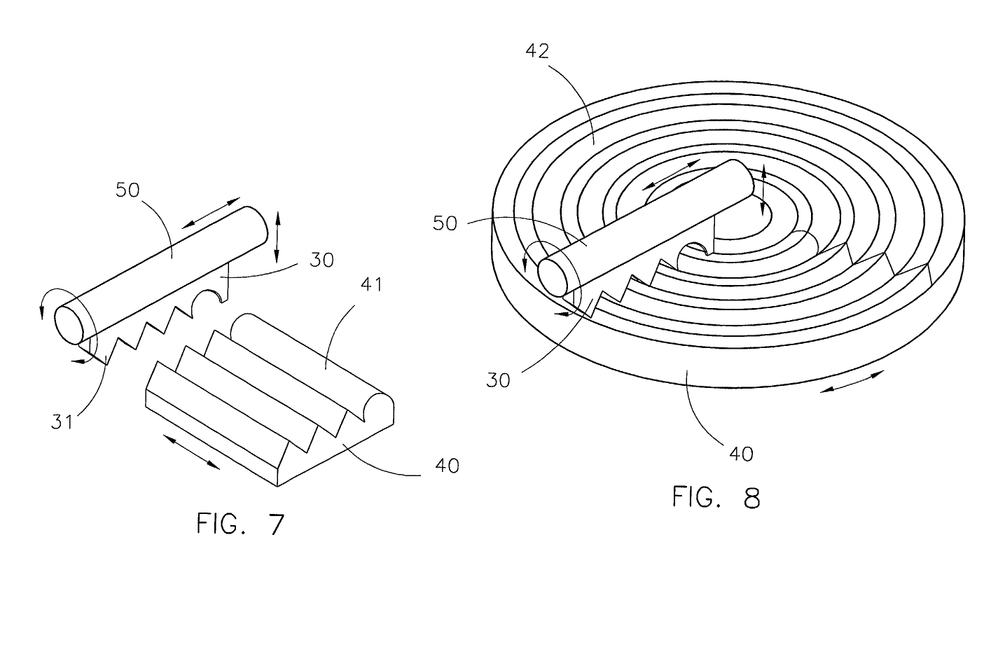

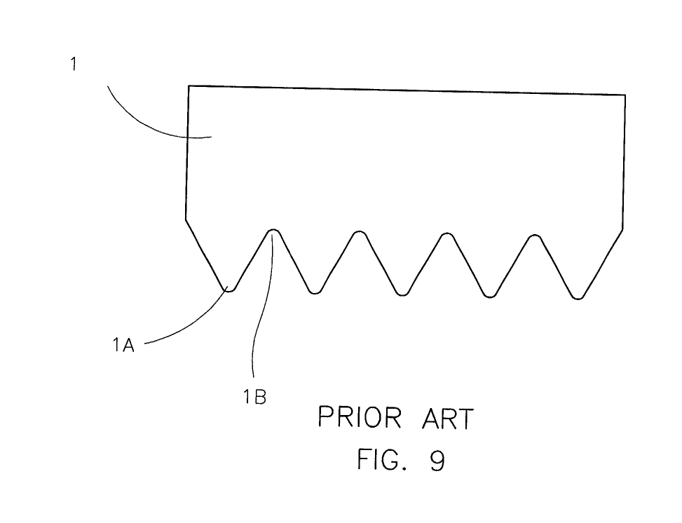

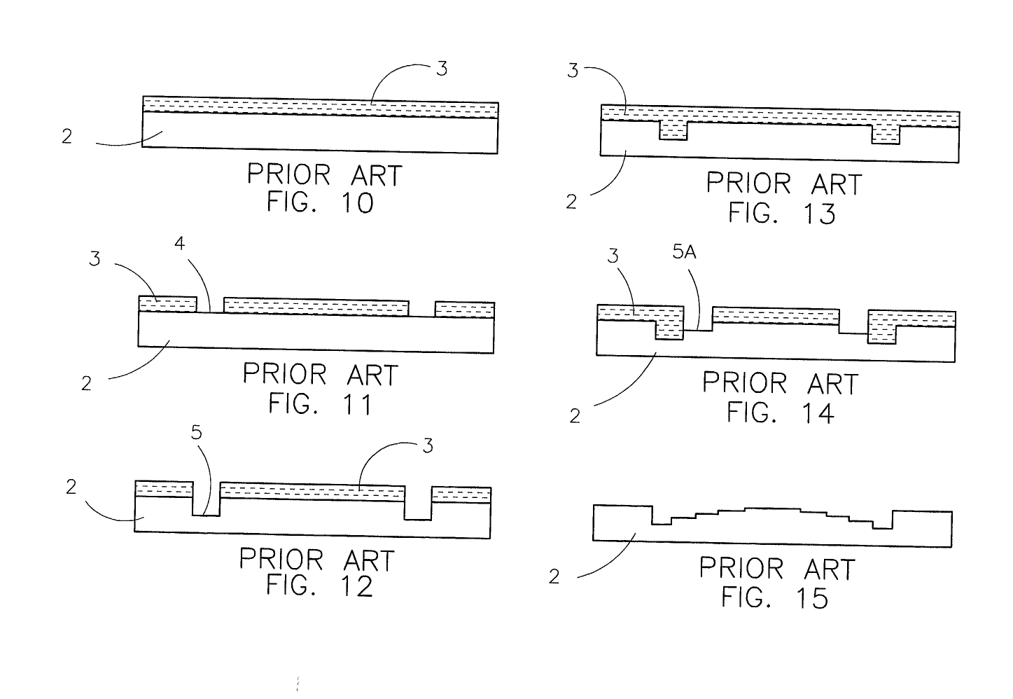

Referring to FIGS. 7 and 8, the micro-cutting tool 30, having been produced, is mounted on a cutting machine to generate a 3-dimensional microstructure on the work object 40. In an embodiment shown in FIG. 7, the micro-cutting tool 30 is turned by a certain angle, then mounted on a cutting machine seat 50 to generate a 3-dimensional microstructure 41 on the work object 40 by fly cutting. In another embodiment shown in FIG. 8, the micro-cutting tool 30 is mounted on the cutting machine seat 50 and rotated to generate a 3-dimensional microstructure 42 of concentric circles on the work object 40.

Compared to 3-dimensional microstructures produced by conventional cutting tools, the micro-cutting tool 30 of the present invention has very good precision of size and shape due to the production method of lithography and electroplating. Since the micro-cutting tool 30 is not fabricated by machining, the shortcoming of rounded edges due to an imperfect production tool is avoided. Therefore it is possible, using the present invention, to generate 3-dimensional microstructures with sharp projections and sharp corners.

Moreover, as compared to 3-dimensional microstructures produced by conventional chemical etching, by using the micro-cutting tool 30 of the present invention for generating 3-dimensional microstructures in a single cutting step, the disadvantage of having repeated light exposing and etching steps is avoided. By machining, connected working steps are fast and conveniently performed. Therefore, the method of the present invention increases speed of production and reduces cost.

As the above explanation shows, the method of the present invention achieves the size and shape precision of chemical etching, while providing the high production speed combined with low cost of machining.

While the invention has been described with reference to preferred embodiments thereof, it is to be understood that modifications or variations may be easily made without departing from the spirit of this invention which is defined by the appended claims.

1. A production method for 3-dimensional microstructures, comprising the steps of:
a. generating an photoresist mold by photolithography for producing a micro-cutting tool;
b. producing said micro-cutting tool by electroplating in said engraved mold; and
c. mounting said micro-cutting tool on a cutting machine and performing cutting of a work object by said micro-cutting tool, generating a 3-dimensional microstructure on a surface of said work object shaped according to said micro-cutting tool.

2. A production method for 3-dimensional microstructures according to claim 1, wherein said micro-cutting tool performs fly cutting on said work object or other machining method.

3. A production method for 3-dimensional microstructures according to claim 1, wherein said micro-cutting tool performs circular cutting on said work object or other machining method.

4. A production method for 3-dimensional microstructures according to claim 1, wherein said micro-cutting tool is made of one of the following hard materials: Ni, NiFe alloy, NiCo alloy, NiW alloy, a composition of Ni and SiC, or another similar material.

5. A micro-cutting tool for generating a 3-dimensional microstructure, having cutting edges that correspond to said 3-dimensional microstructure for cutting out said 3-dimensional microstructure from a work object, and being produced by generating an engraved mold of equal shape on a substrate using photolithography, then electroplating in said engraved mold.

6. A micro-cutting tool for generating a 3-dimensional microstructure according to claim 5, wherein said micro-cutting tool is made of one of the following hard materials: Ni, NiFe alloy, NiCo alloy, NiW alloy, a composition of Ni and SiC, or another similar material.

7. A micro-cutting tool for generating a 3-dimensional microstructure according to claim 5, wherein said micro-cutting tool performs fly cutting on said work object or other machining method.

8. A micro-cutting tool for generating a 3-dimensional microstructure according to claim 5, wherein said micro-cutting tool performs circular cutting on said work object or other machining method.
